(19) United States
(12) Patent Application Publication
(10) Pub. No.: US 2015/0055898 A1
(43) Pub. Date: Feb. 26, 2015

(54) HYDRODYNAMIC AXIAL BEARING

(71) Applicant: ESK Ceramics GmbH & Co. KG, Kempten (DE)

(72) Inventors: Armin Kayser, Buchenberg (DE); Ursula Kayser, Buchenberg (DE); Dietmar W. Schonhoven, Kempten (DE); Johanna Zimmermann, Luebeck (DE)

(21) Appl. No.: 14/347,166

(22) PCT Filed: Aug. 31, 2012
(86) PCT No.: PCT/EP2012/066950

§ 371 Date: Nov. 11, 2014

(30) Foreign Application Priority Data
Sep. 26, 2011 (DE) 10 2011 114 413.0

(51) Int. Cl. F16C 17/04; F16C 33/04; F16C 33/20

(52) U.S. Cl. CPC F16C 17/047; F16C 33/201; F16C 33/043
USPC 384/123

(57) ABSTRACT

The invention relates to an axial bearing comprising a slide ring (1), a counter-ring (2) and an elastic mounting (3) of the slide ring, wherein the slide ring (1) is integral and has a structuring on the running surface thereof which enables the development of a stable, hydrodynamic lubricating film and wherein the structuring of the running surface occurs so that the running surface has three or more elevations (6), wherein the contact surfaces (8) thereof are even with the counter-ring (2).

### TECHNICAL REALM

The invention relates to a medium-lubricated hydrodynamic axial bearing that generates very low frictional loss, is suited for high output levels, and may be manufactured of polymer-plastic materials.

### BACKGROUND OF THE INVENTION

Medium-lubricated axial bearings are used, for example, for shaft bearings in seal-less magnetically-coupled pump drives, where they take up the thrust load from the pump wheel. In this type of pump, the medium is statically sealed by means of the so-called split pot. This requires no dynamic shaft bearing. The drive of the pump shaft is via a magnetic coupling, i.e., by means of a magnetic field acting through the split pot by an external drive on the inner pump shaft. This type of pump meets the highest demands for service life, freedom from leakage, and energy efficiency, and is finding increasing application for high-efficiency circulation pumps.

With this type of pump, frictional loss arises only at the two radial bearings, and to a higher degree at the axial thrust bearing that must simultaneously withstand the pump differential pressure. System friction losses at the axial thrust bearing therefore have their greatest portion of frictional loss, especially with pumps of lower output and high rotational speed (RPM).

### PRIOR ART

In today's types of pumps with medium-lubricated axial thrust bearings, most designs employ a slip-ring/counter-ring pair of the materials combination of graphite against aluminum oxide. This pairing allows achieval of high service life of over 10 years, with frictional coefficients of about 0.05.

These frictional coefficients, however, are too high for energy-saving high-efficiency pumps, and would mean that up to 30% of pump output could be lost to friction. Also, the costs of such bearing pairs are too high for large-scale application since graphite and ceramics, the two materials used, are sintered materials that must be manufactured using the process steps of shaping and thermal treatment. At least one of the bearing surfaces must also be lapped or polished in order to ensure functionality of the bearing. Moreover, this pairing of materials without hydraulic design does not operate noiselessly because of the very high e-modulus of the ceramics and the graphite materials used, as may be required in some applications. Typical graphite materials possess an e-modulus of 27 GPa, and sintered ceramics of 400 GPa.

To optimize the tribologic conditions and to avoid running dry, axial friction bearings in conventional applications are provided with one or more lubricant fittings. Even using these designs and independent of material, frictional coefficients of 0.05 cannot be improved by reduction.

It is further known that axial bearings may be tribologically improved by means of a hydrodynamic design. This is already being implemented in new pump designs with graphite/ceramic bearing pairs. Low frictional coefficients down to 0.01 may be achieved using fine textures for the flow surface. A wedge gap (flat, oblique lubricating wedge) and the wedge gap with contact surface have proved useful for fine textures. A disadvantage of this approach, however, is that the hydrodynamic fine textures used will wear down over the service life, and a longer run-in period is required to achieve a low frictional coefficient. A further disadvantage of this approach is wide variations in frictional coefficient over the service life and within a production series.

It is further known that step-shaped lubricant gaps may possess greater carrying force than a wedge gap if one assumes infinite width. With an infinite width of the wedge gap, this theoretical advantage collapses because the highest pressure on the step occurs at the point where the lubricant-flow cross-sectional area (lateral flow) is large, so that such a bearing with low width is even worse than pivoted-pad slider bearing (G. Rothley, Overview of theoretical and experimental results of dynamic radial and axial bearings in laminar and turbulent areas. Literature study, Karlsruhe Kernforschungszentrum [Nuclear Research Center], 1969 p. 78). From Hamrock et al. (Fundamentals of Fluid Film Lubrication, 2004, p. 229) regarding a step-shaped lubrication gap: “This bearing has not, however, enjoyed the same development and applications as the pivoted-pad slider bearing (Kippsegmentlager). Past neglect of this mathematically preferable configuration has been due to doubts about the relative merits of this bearing when side leakage is considered.”

Polymer-based materials have not yet found wide application in medium-lubricated pump bearings, although the amount of polymer materials in pump components increases with each new generation of pumps, particularly for cost reasons. The materials-related disadvantages are poor thermal dissipation (<1.0 W/m*K), a low degree of shape stability under pressure load, and inadequate wear resistance. A significant reason not to use polymers as bearing materials is the high rotational speed of about 3,000 RPM that results from a power-grid frequency of 50 and/or 60 Hz. Because of this, high frictional heat arises that can be dissipated very poorly by polymer materials. Additionally, the polymer materials fail mechanically at relatively low temperatures caused by their relatively low glass-transition temperatures. Circulation pumps are also often operated in pressurized water systems at up to 140° C. Under these conditions, many conventional polymer materials fail because of hydrolysis and/or loss of mechanical stiffness.

WO 2009/135120 A2, U.S. Pat. No. 5,567,057, and US 2004/0057642 A1 describe design approaches for axial bearing configurations of metallic design materials. In these approaches, the slip ring is not monolithic, but rather consists of several pieces with segments. WO 2009/135120 A2 describes an approach using pellet segments, U.S. Pat. No. 5,567,057 describes an approach using so-called pivoted-pad slider segments, and US 2004/0057642 A1 describes another segment approach. These designs are suitable for high loads and large shaft dimensions, and allow hydrodynamic flow behavior even with polymer materials, but cannot be implemented for pumps with smaller shaft diameters of less than about 20 mm because of the lack of available installation space and the considerable design cost.

US 2006/0034556 A1 describes an axial bearing design of metallic materials with hydrodynamic texturing across a wavy surface. The disadvantage to this approach is the fact that it does not allow stable, low frictional coefficients across its service life when implemented in graphite or polymer materials. With even a low amount of wear at the concave tips, the hydrodynamic effect is altered, and can deteriorate into normal mixed friction upon wear of a few hundredths of a millimeter.

WO 2007/081639 A2 and WO 2006/083756 A2 propose an axial bearing design suitable for polymer materials that allows a stable hydrodynamic effect even with wear to the polymer slip ring. Pockets are formed below the friction surface of the bearing ring. The friction surface of the slip ring that is flat in unloaded condition becomes wave-shaped under pressure through elastic deformation toward the pockets, by means of which the formation of a hydrodynamic lubricating film is promoted. For geometric reasons, this approach is suitable only for large shaft diameters. For smaller shaft diameters, the elastic deformability of the polymer materials is inadequate to form the wave structure required for the function. This bearing technique may therefore be used only in larger pumps with shaft diameters larger than about 30 mm. Additionally, the manufacture of very complex pocket shapes is very expensive for manufacturing equipment, and is suited only for small series and special pumps.

DE 19719858 A1 proposes recipes for resin molding material with tribologic-acting filler materials for use as a coating for axial bearings, but without describing a suitable design implementation of the axial bearing to stabilize the hydrodynamic lubricating film. Frictional coefficients of 0.05 are achieved with the flat sample bodies used here. The frictional performance and heating arising at these frictional coefficients do not allow the use of polymer friction bearings in pump bearings with higher loads.

WO 97/26462 describes an embodiment example for a combined axial/radial bearing of high-performance polymer material, preferably of the sintered polymer Polyimide. However, the structure of a stable hydrodynamic lubricating film at the axial bearing is not possible with the proposed flat axial design. Also with this bearing design, the use of polymer friction bearings in pump bearings with higher loads is not possible because of the friction and frictional heat arising.

### Task of the Invention

It is therefore the task of the invention to provide a hydrodynamic axial bearing that is low-friction and wear-proof over long operating periods while avoiding the disadvantages of Prior Art, and that is also suited for manufacture with polymer materials, and that is simple in design in that it is a monolithic bearing that is also suited for smaller to medium shaft diameters up to 20 mm.

### Abstract of the Invention

The above-mentioned task is solved by means of an axial bearing comprising a slip ring, a counter-ring, and an elastic bearing of the slip ring per patent claim 1. Advantageous and/or particularly useful embodiments are given in Dependent claims 2-20.

The subject of the invention is thus an axial bearing comprising a slip ring, a counter-ring, and an elastic bearing of the slip ring, whereby the slip ring is monolithic and possesses a texture on its running surface that allows the formation of a stable hydrodynamic lubricating film, and whereby the texturing of the running surface occurs in a manner such that the contact surface comprises three or more projections whose contact surfaces with the counter-ring are flat.

The axial bearing based on the invention allows the stable formation of a hydrodynamic lubricating film, and is distinguished by very low frictional loss and low wear.

Another advantage of the axial bearing based on the invention is the application option of low-cost polymer bearing materials. The bearing design thus allows the use of sintered-graphite materials previously used as the standard in pump applications. This makes the use of polymer materials for axial bearings in high-load pumps with small shaft diameters up to about 20 mm possible for the first time. Polymer segment bearings and other special designs known to Prior Art cannot be used in these pump designs because of the large installation space required.

A further advantage consists of the simple, compact design as a single-disk axial bearing (i.e., axial bearing with monolithic structure of the slip ring), by means of which an economical, simple, and compact approach has been found through which expensive former designs such as, for example, segment bearings and expensive tribo-materials like sintered ceramics and graphite, may also be advantageously replaced in larger pumps.

The friction-loss coefficient of the axial bearing based on the invention is reduced by a factor of at least 5 with respect to conventional axial bearings of graphite or sintered ceramics with flat slip rings or slip rings provided with lubricating slots per Prior Art. With the axial bearing based on the invention, frictional coefficients may be kept to below 0.01, while the achievable frictional coefficients for conventional axial bearings of graphite or sintered ceramics are 0.05 or higher.

Thus, using the axial bearing based on the invention, frictional coefficients of clearly below 0.05 and even below 0.01 may be achieved for high-load pump bearings with small shaft diameters up to about 20 mm, while axial bearings with large shaft diameters may be implemented with considerably-reduced design cost in the form of a single-disk axial bearing for which a frictional coefficient around 0.01 was previously possible only with great design expense such as, for example, with segment bearings that possess very low frictional coefficient of 0.01 or lower.

The frictional heat output in the axial bearing based on the invention is also reduced by a factor of at least 5 with respect to conventional axial bearings of graphite or sintered ceramics with flat slip rings or slip rings provided with lubricating slots per Prior Art. Thus, a high heat-dissipation capacity of the slip rings is no longer required, and violation of the glass temperature of polymer materials is avoided. This represents a necessary pre-requisite for successful use of polymer materials for the described bearings.

The frictional loss of the axial bearing based on the invention is significantly reduced in comparison with axial bearings with hydrodynamic wedge gap, and is stabilized for long service life. Frictional coefficients of 0.01-0.02 have been achieved in some experiments with polymer materials and graphite using a hydrodynamic wedge gap that are not, however, stable over long service periods. The structuring of the slip ring of the axial bearing surprisingly allowed achieval of frictional coefficients significantly below 0.01 that also allow very stable optimization of friction over the service period.

The step-shaped lubrication gap has been known to Prior Art as a theoretical possibility for hydrodynamic texturing, but it was not expected that it would prove worthwhile with regard to the achieval of the lowest frictional coefficients in comparison to wedge gap textures since the technical prediction existed that the step-shaped lubrication gap would be disadvantageous when lateral flow (side leakage) is taken into account.

It was further to be expected that the high surface pressure with the small contact surface of the slip ring for polymer materials with comparatively low e-modulus and wear resistance would lead to a very high wear rate, which surprisingly is not the case.

With the hydrodynamic texturing of the slip ring, the concept of lubricating pockets, or depressions in the contact surface, is totally abandoned. Rather, the slip ring of the axial bearing based on the invention possesses only a few projections (three or more, but preferably only three). Reduction of the contact surface to preferably maximum 50% of the projected running surface can generate a very stable hydrodynamic lubricating film in polymer materials.

In comparison experiments, it has been shown that very low frictional coefficients with high statistical and service-life stability maybe achieved through the hydrodynamic texturing based on the invention. These stable and very low frictional coefficients cannot be achieved using conventional hydrodynamic textures as known to Prior Art. This also applies for conventional bearing materials such as, for example, graphite or ceramics.

A decisive advantage of this design with monolithic bearing rings of smaller dimensions is also the fact that the step height may be made comparatively high for geometric reasons. Thus, for example, step heights of 0.5 mm may be created, while step heights of only 0.05 mm are possible for wedge/contact-surface textures in smaller bearing rings. This results from the small wedge angles necessary for the function of the wedge surfaces.

It was shown that the smallest frictional coefficients resulted across a wide range of step heights of the projections in the texturing of the running surface of the slip ring based on the invention. Thus, this texturing of the running surface of the slip ring can tolerate considerable wear in the range of several tenths of a millimeter over its service life, while alternative embodiments with lesser step height such as, for example, wedge/contact-surface textures, can tolerate only a few hundredths of a millimeter.

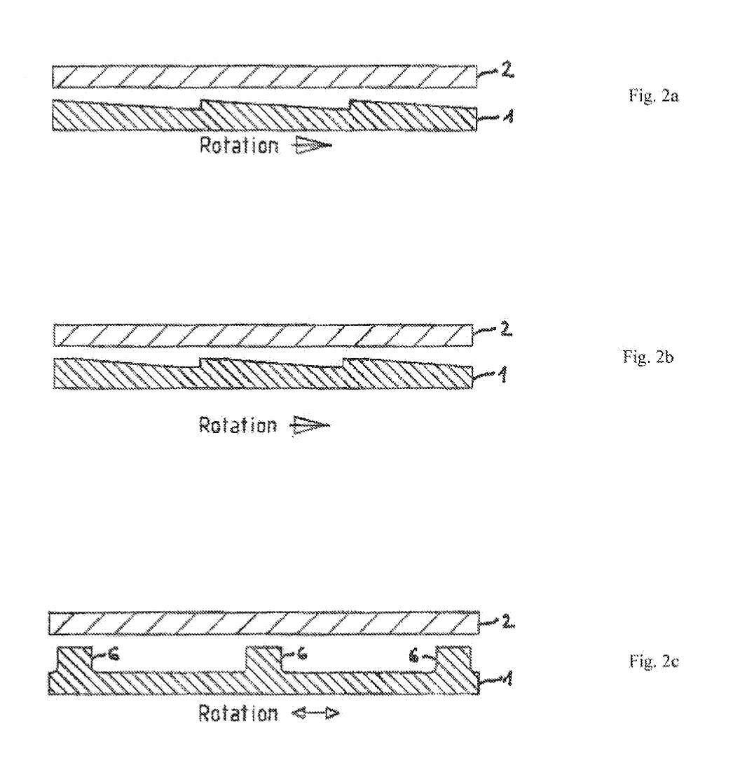

In comparison with axial bearings with hydrodynamic wedge-gap textures, the described design also has the advantage of bi-directional function (see FIG. 2). In principle, this is also possible with counter-rotating wedge-gap approaches, but requires a significantly higher circumferential length, which is not available with smaller shaft diameters.

The axial bearing based on the invention distinguishes itself through very stable frictional coefficients of clearly under 0.01 even after a very brief run-in period of a few minutes. Conventional tribo-pairs require run-in times of several hours.

Another advantage of the axial bearing based on the invention is the fact that only a low amount of running noise arises with the use of polymer materials for the slip or counter-ring because of the low e-modulus and the hydrodynamically-generated lubricating film. Under test conditions, these pairings operate without wear and very quietly.

The axial bearing based on the invention allows the use of axial-bearing rings of polymer-based materials, particularly in pumps of smaller to medium shaft diameters. The axial bearings in the pump types have formerly been predominantly manufactured of sintered ceramics, carbides, or graphite.

Use of manufacturing of the bearing rings based on the invention of polymer materials using the thermo-plastic injection molding process with no mechanical post-processing avoids cost-intensive manufacturing processes. Particularly, thermal process and mechanical processing lead to high manufacturing costs for conventional bearing materials.

The advantageous reinforcement of the polymer materials by means of suitable ceramic filler material allows a significant reduction of abraded material from wear and thus increases the service life of the bearing even under critical worst-case conditions such as abrasive particles in the medium or a high degree of roughness of the counter-bearing surface.

Surprisingly, it was also shown during this that the combination of materials-specific design of the bearing configuration, selection of suitable base polymer materials and, as necessary, suitable reinforcing materials, along with surface processing of the counter-ring, not only allow achieval of tribologic index values of graphite bearings, but also are particularly clearly superior with regard to frictional coefficient, wear, and stability of the friction behavior.

### BRIEF DESCRIPTION OF THE INVENTION

The invention will be described in greater detail using Figures, which show:

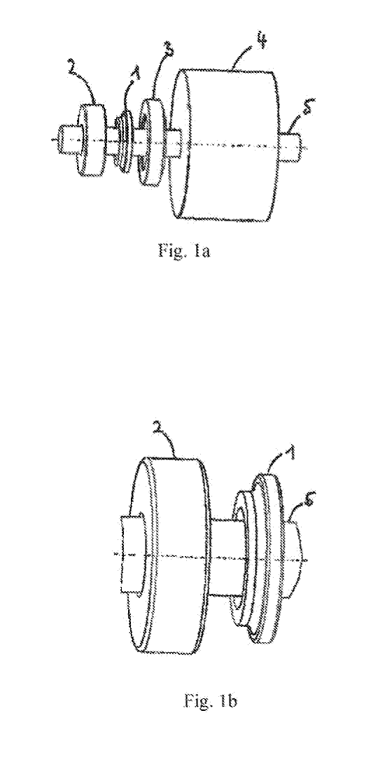

FIGS. 1a and 1b perspective view of a bearing configuration per Prior Art for axial support of drive shafts;

FIGS. 2a-2c comparison of hydrodynamic textures as a cross-sectional view of the slip ring 1, whereby FIGS. 2a and 2b show Prior Art and FIG. 2c shows the invention;

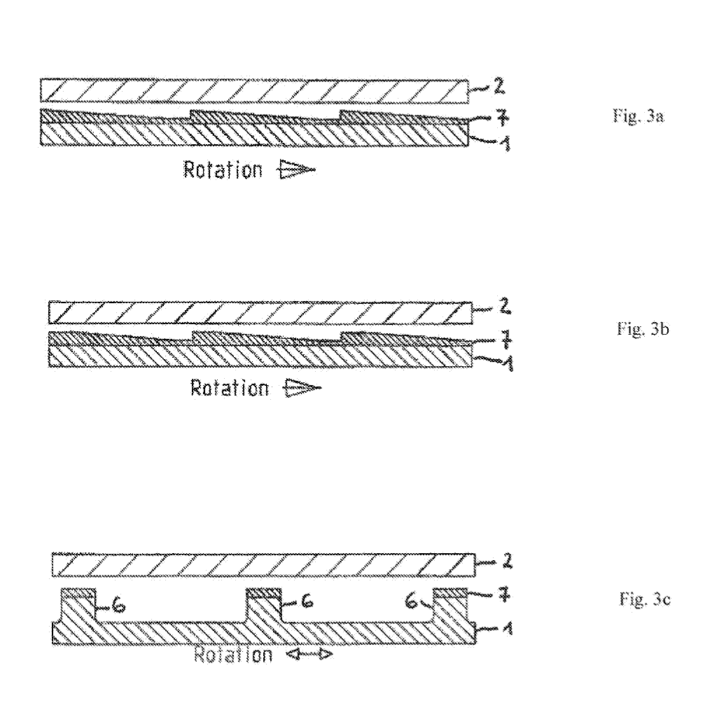

FIGS. 3a-3c cross-sectional view of the slip ring 1 whereby FIGS. 3a and 3b show Prior Art and FIG. 3c shows the invention;

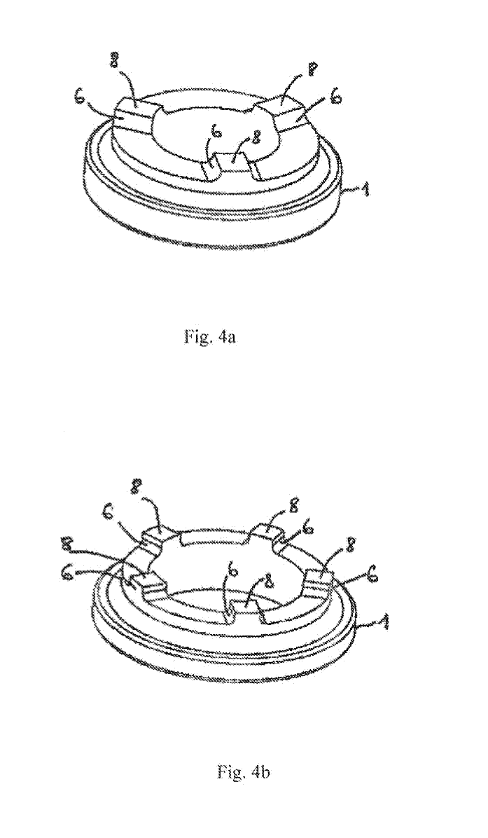

FIGS. 4a and 4b perspective view of the configuration of the projections on a slip ring based on the invention;

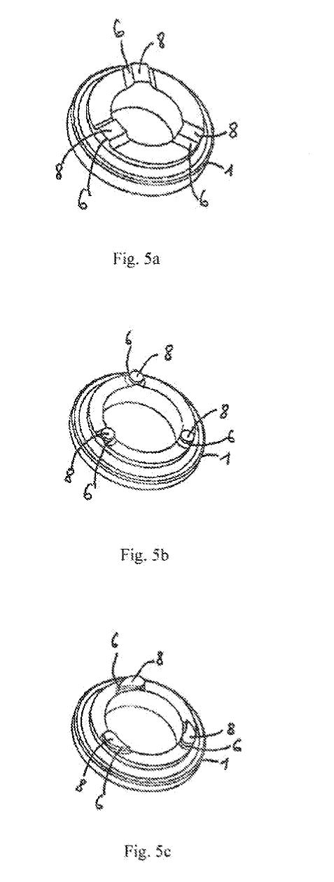

FIGS. 5a-5c perspective view of various possible shapes of projections and/or contact surfaces of a slip ring based on the invention;

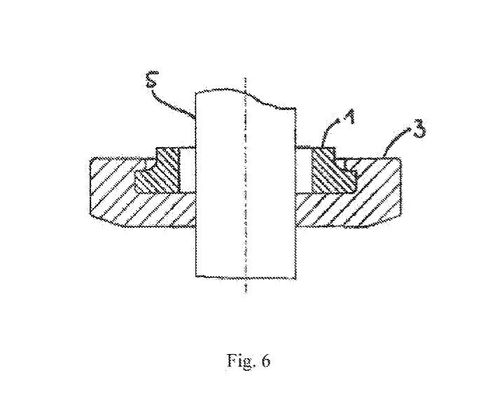

FIG. 6 cross-sectional view of the elastic mounting of a slip ring based on the invention;

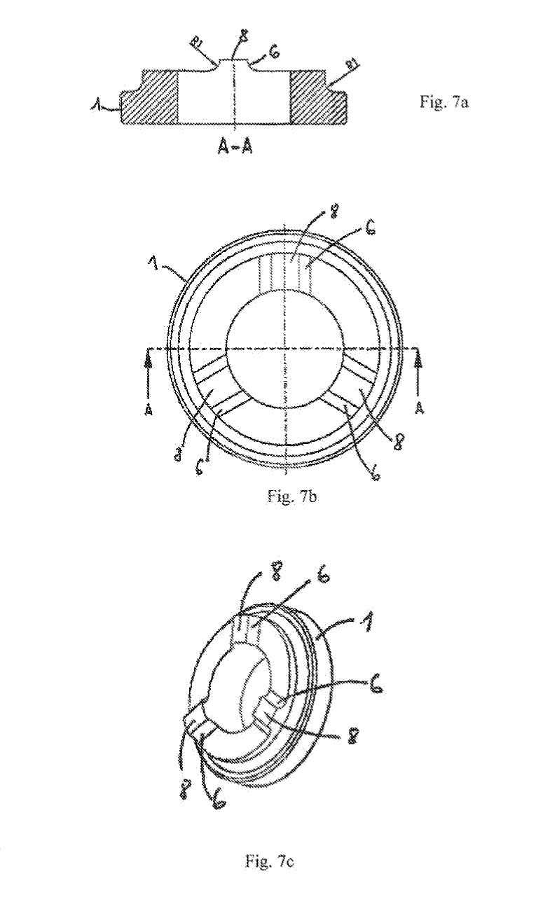

FIGS. 7a-7c advantageous embodiment of a slip ring based on the invention;

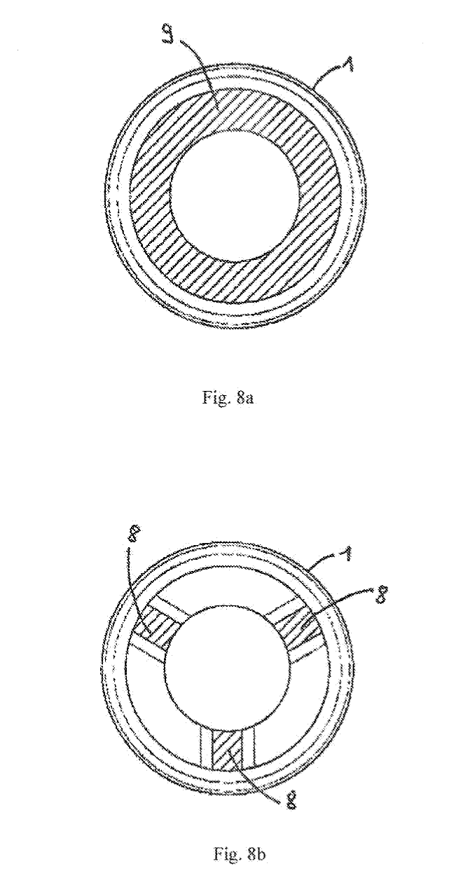

FIGS. 8a and 8b top view of the slip ring shown in FIGS. 7a-7c; and

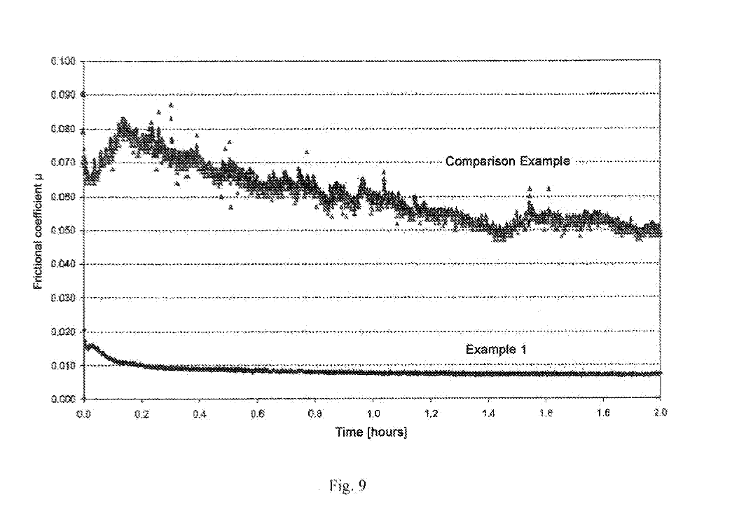

FIG. 9 temporal progression of measurement of frictional coefficient for Example 1 and the comparison example.

### DETAILED DESCRIPTION OF THE INVENTION

FIGS. 1a and 1b show a perspective (exploded) view of a bearing arrangement per Prior Art for axial support of drive shafts in magnetically-driven pumps. The slip ring (rotating ring) 1 is connected via an elastomer receptacle 3 by friction fit to the rotor 4 (magnet). The counter-ring (static ring) 2 is connected statically to the surrounding housing (e.g., by means of force fit), and serves simultaneously for radial support of the shaft 5. Thus, the slip ring 1 rotates with the shaft rotational speed against the counter-ring 2.

The surface pressure between slip and counter-ring results from the axial thrust of the pump wheel (centrifugal or compressor wheel) mounted on the shaft 5. This wheel is located outside the bearing arrangement, and is not shown in FIG. 1. A frictional moment arises as a braking moment on the slip ring, thus increasing necessary drive power.

The radial mounting of the shaft 5 also leads to a braking moment that is small, however, because of the relatively small radial forces in rotating pumps.

FIGS. 2a-2c show the comparison of hydrodynamic textures for the described application as a cross-sectional view of the slip ring 1. The flat counter-ring 2 is also shown. Per Prior Art, this texture is implemented, for example, as a simple wedge gap (FIG. 2a) or wedge gap with engaging surface (FIG. 2b). These designs in the illustrated embodiment are tribologically effective only in one rotational direction. For counter-rotating wedge gaps, these designs are tribologically effective in both rotational directions, but with approximately twice the installation space and/or circumferential length of the bearing surface.

In contrast, the texturing based on the invention with step-shaped projections 6 (FIG. 2c) are very compact with relatively high potential contact surface and bi-directional rotation function. A small contact surface can support the hydrodynamic effect. On the other hand, a small contact surface also causes a high specific surface load (pressure). Especially with polymer materials with relatively low e-moduli and pressure resistance, small contact surfaces can thus cause limitation to pressure load capacity so that, for applications with higher pressure load capacity, larger contact surfaces are useful, and are also possible with the texturing with step-shaped projections based on the invention.

FIGS. 3a-3c show a cross-sectional view of the slip ring 1 (with flat counter-ring 2 shown) and the effect of material wear of about 0.05 mm, as may occur over the service life of pumps dependent on usage conditions in less than one year of operation. The abraded-material volume 7 is shown with fine shading. Upon wear of 0.05 mm in FIGS. 3a and 3b per Prior Art, the hydrodynamic texture is completely worn away, which results in the fact that frictional coefficient-reducing effect of the hydrodynamic lubrication is no longer present. This texturing is thus less suited for polymer bearings.

In contrast, the texture based on the invention with three or more projections (FIG. 3c) remains in place even with higher abraded-material volume, and remains hydrodynamically effective.

FIGS. 4a and 4b show a perspective view of the arrangement of the projections 6 with the supporting surfaces (contact surfaces) 8 on the slip ring. A minimum of three (FIG. 4a) or any larger number of individual contact surfaces are mounted about the circumference (5 individual contact surfaces in FIG. 4b). With the same size of individual supporting surface, a design with more than three contact surfaces can distribute the axial pressure onto a larger surface, thus reducing the specific surface pressure.

FIGS. 5a-5c show a perspective view of various possible shapes of the projections 6 and/or the individual supporting surfaces (contact surfaces) 8. The surfaces may be shown as polygons or, as shown here, quasi-rectangular shaped quadrangles (FIG. 5a), round (FIG. 5b), or, for example, as flow-optimized asymmetrical or non-round shape (FIG. 5c).

FIG. 6 shows a cross-sectional view of the mounting of the slip ring 1 that is per Prior Art connected to the rotor via an elastomer receptacle 3 by friction fit. The slip ring 1 itself is not on the shaft 5, and may therefore be positioned at an angle slightly off the perpendicular to the shaft. Because of the elastomer receptacle and the angle tolerance, the slip ring 1 is pressed evenly about its circumference against the counter-ring. Thus, shape and positional tolerances are matched, and a stable hydrodynamic effect is promoted. The elastic mounting is also possible as in bearing and gasket techniques using spring-elastic elements.

FIG. 6 shows a particularly advantageous embodiment that allows simple pre-assembly and reliable positioning.

FIGS. 7a-7c show an advantageous embodiment of the slip ring 1 with three quasi-rectangular supporting surfaces (contact surfaces) positioned at an angle of 120° from one another in cross-sectional view (FIG. 7a), top view (FIG. 7b), and a perspective view (FIG. 7c). The height of the projections 6 with the supporting surface 8 may, for example, be varied between 0.1 and 1 mm without decisively negatively affecting the stable hydrodynamic flow. The design is very simple and low-cost to implement in polymer materials using the injection-molding process. The shaping of the outer diameter is not relevant to function, and is determined by the shape of the elastomer receptacle as shown in FIG. 6. The transitional radii R1 from the ring to the projections with the contact surfaces are determined by the shape, and are also not relevant to function.

The embodiment example shown in FIGS. 7a-7c is suited to an axial load of 50 N.

FIGS. 8a and 8b show a top view of the slip ring from FIGS. 7a-7c, whereby here in FIG. 8a, the running surface 9 projected in a plane parallel to the contact surface 8, and the contact surface (supporting surface) 8 in FIG. 8b, are shown with fine shading.

The slip rings shown in the Figures possess a protective bezel about their upper and lower circumferences (see particularly FIGS. 4 and 7), which are not absolutely necessary. These protective bezels are shown in the Figures with some additional lines.

FIG. 9 shows the temporal progression of the measurement of frictional coefficients for Example 1 based on the invention, and for the comparison example.

### DETAILED DESCRIPTION OF THE INVENTION

The axial bearing based on the invention comprises a slip ring, a counter-ring, and an elastic mounting for the slip ring. The slip ring is monolithic (so-called single-disk bearing), and possesses on its running surface, i.e., the contact surface with the counter-ring, a texture that allows the creation of a stabile hydrodynamic lubricating film. This texture of the running surface is created such that the running surface possesses three or more, preferably three, projections whose contact surfaces with the counter-ring are flat.

The projections on the bearing surface are preferably step-shaped along the rotational direction.

The total contact surface of the projections preferably comprises maximum 50% with respect to the running surface projected along a plane parallel to the contact surface of the slip ring, i.e., on the total surface between inner and outer diameters of the bearing surface (running surface) of the slip ring (see FIG. 8). Further, the total contact surface of the projections of the bearing surface is preferably a maximum of 30%, and especially preferably a maximum of 20% of the projected running surface.

The total contact surface of the slip ring preferably has a ratio of 5-30%, particularly preferably 10-20% of the projected running surface.

The projections are preferably evenly distributed across the running surface. It is particularly advantageous for the three projections to be at an angle of 120° from one another.

The elastic mounting of the slip ring may be made, for example, using an elastomer receptacle through which the slip ring is connected to the rotor using a friction fit. The elastic mounting is possible using other spring-elastic elements such as are conventional in bearing and gasket techniques.

In the axial bearing based on the invention, at least one bearing ring of the slip-ring/counter-ring pair is made of polymer material. The bearing ring that rotates with the shaft is known as a slip ring. The stationary bearing ring firmly affixed to the shaft is known as a counter-ring.

The rotating slip ring is advantageously made of the polymer material.

The stationary counter-ring may be made of conventional bearing materials such as, for example, sintered ceramics, graphite, carbide, metal, or bronze. Alternatively, the counter-ring may be made of polymer material.

The bearing surface of the counter-ring should preferably possess a very high surface quality, i.e., low roughness value. It has been shown that frictional coefficient and wear may be significantly reduced by means of reduction of roughness values at the counter-ring. It is particularly advantageous for the counter-ring to have a polished surface.

It is also possible, however, to maintain frictional coefficients of less than 0.1 with a higher degree of roughness on the running surface with surfaces that are merely lapped or honed with simultaneous low wear, so that axial bearings based on the invention with a higher degree of roughness on the running surface are stable over longer service periods.

The surface of the counter-ring preferably possesses a low degree of porosity and a high degree of hardness and thermal conductivity. The high degree of hardness and thermal conductivity are decisive for wear resistance and maximum load-bearing capability of the bearing design regarding pressure and/or rotational speed. Thus, the creation of the hydrodynamic lubricating film is allowed and stabilized, and frictional heat output is well dissipated.

In an advantageous embodiment example of the axial bearing based on the invention, the counter-ring is therefore of a dense, fine-grained sintered ceramic, for example aluminum oxide. The implementation of sintered silicon carbide (SSiC) is particularly advantageous. A suitable silicon-carbide material may be obtained from ESK Ceramics GmbH & Co. under the name EKasic®, which possesses a thermal-conductivity capacity of >120 W/m*K.

The bearing surface of the counter-ring should preferably be implemented with a low degree of smoothness variation. With higher smoothness variation or slots on the bearing counter-surface, the hydrodynamic lubricating film may be destabilized.

In another possible embodiment example, both the slip-ring and the counter-ring are made of a polymer material. This allows even further reduction in total cost for the bearing system. The required high degree of surface quality at the counter-bearing may thus be advantageously directly obtained using a thermo-plastic injection-molding process. Thus, the expensive process steps such as lapping and/or polishing required for sintered materials or metals may be omitted since an adequate degree of surface quality may be achieved during the shaping step of a polymer injection-molding process.

In another equally-possible embodiment example of the axial bearing based on the invention, the slip ring may be made of conventional bearing materials such as sintered ceramics, graphite, carbide, metal, or bronze. This is advantageous for application conditions for which polymer materials cannot be used because of strongly abrasive or corrosive conditions.

In an advantageous embodiment example, the slip-ring of the axial bearing based on the invention possesses three projections (see FIG. 7) that are positioned 120° from one another. The three projections are advantageously step-shaped in the direction of rotation. The flat supporting surfaces have a “rectangular” shape (see FIG. 7). This texturing of the slip ring with three supporting surfaces on the flat counter-bearing stabilizes the running behavior of the axial bearing based on the invention even under high shape and positional tolerances of the overall design.

The height of the projections with the supporting surfaces is preferably between 0.1 and 1 mm. Greater heights are possible, but not required as a rule.

The hydrodynamic texturing of the bearing ring may be advantageously provided when manufacturing the bearing ring of thermo-plastic polymer materials by means of the proper injection-mold shape during thermo-plastic shaping without additional process steps.

It is also possible to implement more than three supporting surfaces. This reduces the pressure on the supporting surfaces in proportion to the overall surface area of the supporting surfaces, which may be particularly advantageous under conditions of high axial load.

The individual supporting surfaces of the three or more supporting surfaces of the slip ring may be configured as desired, e.g., polygonal, circular, or non-round surface (see

FIG. 5). Very low frictional coefficients may even be obtained using round contact surfaces.

The dimensions of the individual supporting surfaces result from the geometric requirements of the bearing size. The overall area as a sum of the individual supporting surfaces is advantageously configured such that the surface pressure does not exceed the pressure-bearing capacity of the bearing material.

Suitable polymer materials for the slip ring and/or counter-ring are polymers with a high degree of chemical and thermal stability under the usage conditions, as well as a high e-modulus to accept the high surface pressures with a low degree of deformation.

Examples for suitable thermo-plastic polymer materials for broad application realms in pump technology are Polyetherimide, Polyphenyl sulfide, and Polyether ether-ketone, liquid-crystal polymers (LCP), but other polymer materials may be used.

Along with thermo-plastic materials, Duroplasts [pressure-setting plastics] such as epoxy resin or sintered polymers such as PTFE or Polyimide may also be used. Implementation using elastomers such as, for example, Polyurethanes or thermo-plastic elastomers (TPE) is also possible for lower mechanical loads.

Polymer materials with added reinforcing fibers such as, for example, carbon or aramide fibers are preferably used. These materials, also known as polymer-matrix composite materials, possess a higher e-modulus. The elastic deformation at a given pressure is reduced as the e-modulus increases, which increases the pressure-bearing capacity of the bearing ring thus manufactured, and increases the pressure load capacity of the axial bearing. Particularly preferred are carbon fibers because of the support of the sliding characteristics and low abrasiveness at the counter-bearing.

The content and specifications of fiber filler materials as known to Prior Art are varied such that the optimum stiffness and strength values result for the particular configuration.

The e-modulus, i.e, the stiffness of the polymer material used for the axial bearing based on the invention is preferably at least 7 GPa. It was determined by experimentation that it is possible with such polymer materials to build up a long-term stable hydrodynamic lubricating film.

It is further advantageous to reinforce polymer materials using hard particles such as, for example, silicon carbide, boron carbide, aluminum oxide, or silicon dioxide. This may increase the surface hardness of the polymer material to the point that the hydrodynamic lubricating film is adequately stable even under high contact pressure. Reinforcement with such particles also increases the wear resistance under dry conditions, and when the bearing starts up. When the bearing starts up, mixed friction with contact of the sliding surfaces occurs for a brief time, which can lead to a high degree of wear in unreinforced bearings.

Reinforcement of the polymer material with hard particles may be instead of, or preferably in combination with, reinforcement with reinforcing fibers.

Silicon carbide particles are preferably used as hard particles to increase wear resistance of the polymer material. SiC filler materials possess a hardness index of >9.5 Mohs, and are thus harder than all naturally-occurring abrasives (except diamond). Also, SiC possesses very good corrosion stability in almost all fluid pump media which is far better than the stability of known polymer-matrix materials.

Another advantage of implementation using SiC filler materials is the very high degree of thermal conductivity of SiC of >120 W/m*K, whereby the frictional heat arising in the composite material may also be more effectively dissipated.

Since coarse-grain ceramic filler materials possess a high degree of abrasiveness during processing and in tribo-contact with the counter-ring, very fine grains of less than 1 μm (sub-micron particles) are preferably used that are no longer abrasive because of small particle size.

The content of hard particles may be selected over a wide range up to the theoretical packing limit of the particles. The practically-usable range that still allows good mechanical properties lies between 1-30% by weight.

The content and specification of the hard particles, as well as the mixture ratio between fibers and hard particles is varied from that known to Prior Art such that optimum hardness, stiffness, and strength values result for the particular configuration. The total content of fibers and hard particles lies preferably between 1-40% by weight, and particularly advantageously between 20-40% by weight.

Polymer materials will filler-material combinations of carbon fibers with sub-micron SiC particles have proved to be particularly advantageous for the axial bearing based on the invention.

Wear resistance of these polymer/SiC/carbon-fiber materials (polymer-matrix materials with embedded carbon fibers and SiC particles) in combination with the axial bearing based on the invention with implementation of the counter-ring in ceramic materials such as aluminum oxide or silicon oxide lies far above those for graphite materials.

This also applies under worst-case conditions such as, for example, abrasive loading. Materials testing also demonstrated the high degree of wear resistance of this class of materials without the use of hydrodynamic effects.

Additives such as, for example, lubricants, oils PTFE, graphite, and hexagonal boric nitride may also be used to optimize the gliding and mechanical characteristics.

The axial bearing based on the invention may be used in hot-water circulating pumps, drinking-water pumps, cooling-water circulating pumps for combustion engines and electric drives, compressor pumps for coolant-compression circuits, or cooling-water circulating pumps to cool switching cabinets, hydraulic systems, or laser devices.

The axial bearing based on the invention may also be used in applications in corrosive media such as alkalines and acids, solvents, oils, and low-viscosity greases.

Further, the axial bearing based on the invention is also suited for use for axial bearings in electric motors, particularly small electric motors, as long as permanent lubrication with oils, greases, or other lubricating media is provided.

Furthermore, use of the axial bearing based on the invention is possible for so-called thrust bearings in transmissions. The load situation is similar to a pump bearing, and permanent lubrication with lubricating media is provided.

### EXAMPLES, COMPARISON EXAMPLE, AND REFERENCE EXAMPLE

### Example 1

A bearing design per FIG. 1 was implemented. The geometric detailed implementation of the slip ring was per FIG. 7 with three step-shaped projections progressing in the direction of rotation. The radius at the transition from the projection to the base surface of the projections is 1 mm, but is not relevant to the hydrodynamic configuration. The outer diameter of the slip ring is 21 mm, and the inner diameter is 10.5 mm. The inner diameter of the sliding surface is also 10.5 mm, and the outer diameter of the sliding surface is 17 mm. The height of the slip ring at the outside is 3 mm, and the height at the inside is 5 mm. The overall height, i.e., the height at the inside including the projections with the supporting surfaces is 6 mm, and the step height (height of the projections) is 1 mm. The supporting surfaces possess a shape similar to a rectangle (see FIG. 7). The step width (width of the projections) is 3.25 mm, and the step length (length of the projections along the rotation direction) is 2.5 mm. The portion of the surface of the step-shaped projections on the projected running and/or sliding surface, i.e., at the surface between outer and inner diameters of the sliding surface, is 17%.

Implementation of the counter-ring was of sintered Al₂O₃ material with polished surface.

Implementation of the slip ring was of the polymer material Polyphenylene sulfide (PPS) with reinforcing materials of carbon fiber and very fine SiC particles with particle size <1 μm with total content of 35% by weight.

The frictional coefficients were determined on a specially-prepared test stand in the configuration per FIG. 1 by means of trailing moment.

The testing configuration corresponds to a ring-on-ring arrangement.

The medium was kept at constant temperature using a thermostat. The frictional-moment recording was determined by means of a precision measurement cell, and the path recording of the linear wear path was determined by means of a mechanical path recorder. All measurement values were recorded with a timed release. Measurement values were logged as of the start of the motor drive.

The frictional coefficient was determined after a run-in period of one hour as a mean value over one hour. This frictional coefficient represents the system frictional value of the slip-ring/counter-ring pair.

The wear was determined as a linear wear path over time from the slope of the Path/Time curve after run-in and thermal stabilization after one hour.

The pv-values were set as a constant at p=0.5 MPa and v=1.9 msec.

In order to resolve the very small frictional moments accurately (up to 0.002), the drive side was mounted on air bearings. Since the contact was by means of gravity, any axial mounting could be omitted, i.e., only a radial mounting with air bearing was required.

The specific loads of the bearing were at a rotational speed of 3,000 RPM and axial thrust of 50 N. Water (50° C.) was used as medium. Alternatively, water/glycol mixtures may be used up to a glycol content of 50% by volume.

Extremely low system frictional coefficients were measured using the bearing design and materials combination under the system limit conditions of 0.004 with standard deviation of 0.001 mentioned above.

This low frictional coefficient was achieved after a very brief run-in period of only 10 minutes, and remained stable over the entire measurement period of 168 hours (see FIG. 9, showing a running time of only two hours).

### Example 2

Example 1 was repeated, but the counter-ring was implemented as sintered Al₂O₃ material with lapped surface (Rₐ=0.4 μm). Test results are given in Table 1.

### Example 3

Example 1 was repeated, but the counter-ring was implemented as sintered Al₂O₃ material with finely-honed surface. Test results are given in Table 1.

### Example 4

Example 1 was repeated, but the counter-ring was implemented as a SiC material (EKasic® from company ESK Ceramics GmbH & Co.) with polished surface. Test results are given in Table 1.

### Examples 5 Through 7

Example 1 was repeated, but the height of the projections with the supporting surface not 1 mm as in Example 1, but rather was varied per Table 2. The system frictional coefficients determined are given in Table 2.

### Examples 8 Through 10

Example 1 was repeated, but the shapes of the three support surfaces were varied. With a step width of 3.25 mm each (corresponding to the slip-surface width), a step length along the rotation direction of 1.5 mm and 5 mm was implemented (examples 12 and 13) instead of the step length of 2.5 in Example 1, so that the support surfaces possess a quasi-rectangular shape as in Example 1. Furthermore, a slip ring with three round supporting surfaces with a diameter of 2.5 mm each was tested (Example 14). The step height was 1 mm each as in Example 1.

The system frictional coefficients determined are given in Table 3.

### Examples 11 Through 14

Example 1 was repeated, but Polyetherimide was used as the polymer material for the slip ring that was reinforced by SiC filler materials with a content of up to 20% by weight, without the addition of carbon fibers. The same SiC material was used as in Example 1. The tribologic characteristic data are somewhat more difficult to evaluate with respect to the frictional coefficient than in Example 1, but are still lower than graphite materials, for example. Results regarding linear wear and frictional coefficient are given in Table 4.

Table 4 very clearly shows how the wear resistance of a polymer material may be increased in the axial bearing based on the invention by reinforcement with SiC filler materials.

### Example 15

Example 1 was repeated, but the counter-ring was implemented as liquid crystal polymer (LCP) without reinforcement with carbon fibers, but with graphite as tribo-additive. The frictional coefficients determined were 0.01, and linear wear was 1.3 nm.

### COMPARISON EXAMPLE

An axial bearing per Example 1 was implemented. The geometric detailed implementation of the slip ring was per FIG. 1 as a flat single-disk slip ring with a lubrication fitting. Graphite was used as the material for the slip ring.

Implementation of the counter-ring was of Al₂O₃ material with polished surface.

Determination of the frictional coefficient was per Example 1.

The specific loads on the bearing here were at a rotational speed of 3,000 RPM and an axial thrust of 50 N. Water (50° C.) was again used as the medium.

The mean frictional coefficient in this test determined after one hour was 0.05.

This frictional coefficient could first be achieved only after a longer run-in period of one hour (see FIG. 9).

### REFERENCE EXAMPLE

Example 1 was repeated, but Polyetherimide was used as the polymer material for the slip ring without the addition of SiC filler materials and without the addition of carbon fibers. The tribologic characteristic data are given in Table 4. The frictional coefficient is higher than in Examples 2 through 5, and the degree of linear wear is very high.

TABLE 1

| | Counter-ring | Linear | |
|---|---|---|---|
| | surface | wear (μm/hr) | Frictional coefficient μ |
| Example 2 | Aluminum oxide, | 20 | 0.087 |
| | lapped | | |
| Example 3 | Aluminum oxide, | 6.4 | 0.060 |
| | finely honed | | |
| Example 1 | Aluminum oxide, | 0 | 0.004 |
| | finely polished | | |
| Example 4 | SiC (EKasic ® F), | 0 | 0.003 |
| | finely polished | | |

TABLE 2

| | Step height | |
|---|---|---|
| | (mm) | Frictional coefficient μ |
| Example 1 | 1 | 0.004 |
| Example 5 | 0.5 | 0.006 |
| Example 6 | 0.25 | 0.008 |
| Example 7 | 0.1 | 0.009 |

TABLE 3

| | Contact surface | Frictional coefficient μ |
|---|---|---|
| Example 8 | Rectangle | 0.008 |
| | Step length 1.5 mm | |
| Example 1 | Rectangle | 0.004 |
| | Step length 2.5 mm | |
| Example 9 | Rectangle | 0.007 |
| | Step length 5 mm | |
| Example 10 | Round | 0.004 |
| | Diameter 2.5 mm | |

TABLE 4

| | SiC content | Linear wear | |
|---|---|---|---|
| | (% by weight) | (μm/hr) | Frictional coefficient μ |
| Reference | 0 | 1,469 | 0.080 |
| Example | | | |
| Example 11 | 5 | 4.5 | 0.014 |
| Example 12 | 10 | 3.8 | 0.020 |
| Example 13 | 15 | 0.9 | 0.014 |
| Example 14 | 20 | 0 | 0.016 |

1. Axial bearing comprising a sliding ring (1), a counter-ring (2), and an elastic mounting (3) of the sliding ring, whereby the sliding ring (1) is monolithic and possesses a texture on its running surface that enables the build-up of a stable hydrodynamic lubricating film, and whereby the texturing of the running surface is such that the running surface possesses three or more projections (6) whose contact surface (8) with the counter-ring (2) is flat.

2. Axial bearing according to claim 1, whereby the projections (6) of the running surface are step-shaped along the rotational direction.

3. Axial bearing according to claim 1, whereby the entire contact surface (8) of the projections (6) of the running surface amounts to maximum 50%, and preferably maximum 30%, and especially preferably maximum 20% of the running surface (9) projected onto a plane parallel to the contact surface.

4. Axial bearing according to claim 1, whereby the entire contact surface (8) of the projections (6) of the running surface amount to 5-30%, and preferably 10-20%, of the projected running surface (9).

5. Axial bearing according to claim 1, whereby the projections (6) are evenly distributed across the running surface.

6. Axial bearing according to claim 1, whereby three projections (6) are located 120° from one another.

7. Axial bearing per one of claim 1, whereby the height of the projections (6) is between 0.1 mm and 1 mm.

8. Axial bearing according to claim 1, whereby at least one bearing ring of the sliding ring/counter-ring pair is made of a polymer material.

9. Axial bearing according to claim 8, whereby the sliding ring (1) is made of the polymer material.

10. Axial bearing according to claim 8, whereby both the sliding ring (1) and the counter-ring (2) are made of a polymer material.

11. Axial bearing according to claim 8, whereby the polymer material is selected from the group consisting of thermo-plastic materials, duro-plastic materials, and elastomers.

12. Axial bearing according to claim 8, whereby the polymer material is selected from the group consisting of epoxy resin, PTFE, Polyimide, Polyurethanes, thermo-plastic elastomers (TPE), Polyetherimide, Polyphenylene sulfide, Polyether ether-ketone, and liquid-crystal polymers.

13. Axial bearing according to claim 8, whereby the e-modulus of the polymer material is at least 7 GPa.

14. Axial bearing according to claim 8, whereby the polymer material comprises additional reinforcing fibers, preferably carbon or aramide fibers.

15. Axial bearing according to claim 8, whereby the polymer material comprises additional reinforcing particles, preferably silicon carbide, boron carbide, aluminum oxide, and/or silicon oxide particles, particularly preferably silicon carbide particles.

16. Axial bearing according to claim 15, whereby the content of hard particles lies between 1-30% by weight.

17. Axial bearing according to claim 14, whereby the total content of fibers and hard particles is 1-40% by weight, and particularly preferably 20-40%.

18. Axial bearing according to claim 1, whereby the bearing surface of the counter-ring (2) is polished.

19. Axial bearing according to claim 1, whereby the counter-ring (2) is made of a dense, fine-grained sintered ceramic, preferably of aluminum oxide or sintered silicon carbide (SSiC).

20. Axial bearing according to claim 1, whereby the sliding ring (1) is made of sintered ceramic, graphite, cemented carbide, metal, or bronze.
